(19) United States
(12) Patent Application Publication
(10) Pub. No.: US 2007/0072685 A1
(43) Pub. Date: Mar. 29, 2007

(54) Power transmission device

(75) Inventors: Michiyasu Nosaka, Anjo-city (JP); Yasuo Tabuchi, Toyoake-city (JP); Motohiko Ueda, Okazaki-city (JP); Yoshiki Tada, Okazaki-city (JP); Takayuki Suzuki, Hekinan-city (JP)

Correspondence Address: POSZ LAW GROUP, PLC, 12040 SOUTH LAKES DRIVE, SUITE 101, RESTON, VA, 20191, US

(73) Assignee: DENSO CORPORATION, Kariya-city (JP)

(21) Appl. No.: 11/522,917

(22) Filed: Sep. 19, 2006

(30) Foreign Application Priority Data
Sep. 29, 2005 (JP) 2005-284811

(51) Int. Cl. F16D 9/00

(52) U.S. Cl. 464/32

(57) ABSTRACT

The power transmission device (10) comprises: a rotatable rotary part (1) to which a rotary driving force is transmitted from a driving source; and a power transmission shut-off member (3) for preventing an excessive torque from being transmitted between the rotatable rotary part and a rotating shaft (4) of a driven apparatus and threadedly coupled to the rotating shaft. A hub (2) arranged between the rotary part and the power transmission shut-off member to connect them is located between the power transmission shut-off member and the rotating shaft. The power transmission device further comprises a washer (6) located so as to be sandwiched between the hub and the rotating shaft. The washer is separated from the hub, which is not sandwiched between the washer and an end surface (308) of the power transmission shut-off member near the rotating shaft.

### BACKGROUND OF THE INVENTION

1. Field of the Invention

The present invention relates to a power transmission device and, more particularly, is preferably used in a compressor for a vehicle air conditioner operated by an external power source, such as an engine, via a belt etc. by being incorporated therein.

2. Description of the Related Art

A refrigerant compressor for a vehicle air conditioner is driven by an external power source, such as an engine, via a belt, a pulley, etc., and an electromagnetic clutch may be inserted therebetween in order to separate a connection between the engine and the compressor. If, however, an electromagnetic clutch is not inserted, the cost is reduced, and therefore, in some cases, an electromagnetic clutch may be omitted. In this case, in a power transmission device of a compressor for a vehicle air conditioner operated by an external power source such as an engine via a belt etc., a torque limiter is installed in order to avoid a trouble such as belt damage if the compressor seizes.

Torque limiters include one in which a part of the power transmission path is threadedly joined to utilize an excessive axial force generated at the threadedly joined part due to an excessive torque when the compressor seizes (for example, refer to patent document 1). As described above, in a conventional power transmission device for transmitting power to a compressor, a power transmission shut-off device (torque limiter) is arranged in order to avoid a trouble such as damage to a belt for power transmission when the compressor seizes. Conventionally, a power transmission shut-off device (torque limiter) having a structure in which a portion of a power transmission portion is threadedly inserted has been proposed and a torque limiter system that utilizes threaded insertion is a system for cutting off the power transmission path by rupturing a portion of the power transmission path using an excessive axial force generated at the threadedly inserted portion by the excessive torque generated when the compressor seizes up. In other words, the torque limiter system has a structure in which the power transmission shut-off member is broken by a tensile force of the excessive axial force generated by threaded fastening using the excessive torque generated by the seizing up phenomenon of the compressor. However, when the power transmission shut-off member ruptures, depending on the shape of the ruptured part, there is a possibility that there occurs a case where the thread portion of the power transmission shut-off member is re-fastened. In this case, a gap space formed by the power transmission shut-off member and the bearing surface of an inner hub accommodating the power transmission shut-off member is eliminated and the seat surface of the inner hub is sandwiched by the thread portion of the power transmission shut-off member and the shaft end surface of the compressor, and thus there has been a trouble that power cannot be shut off.

A conventional power transmission device 50 having the above-mentioned problem is explained with reference to FIG. 10 to FIG. 12. FIG. 10 shows a partial side section view of a conventional example of a power transmission device utilizing threaded fastening and FIG. 11 and FIG. 12 are partial side section views showing two states in which the torque limiter (power transmission shut-off member) of the power transmission device 50 shown in FIG. 10 has operated and has been ruptured. In the configuration of the power transmission device 50 shown in FIG. 10, rotation of a power source such as an engine is transmitted to a pulley via a belt etc. and further transmitted to the power transmission device 50 assembled to the pulley. The configuration of the power transmission device 50 is fundamentally the same as that of the power transmission device of the present invention shown in FIG. 1 etc. and will be described later, and therefore, the details are not explained here. In the power transmission device 50, power is first transmitted to a hub and then transmitted in the order of the power transmission shut-off member and the rotating shaft of the compressor etc. threadedly fastened to the power transmission shut-off member.

In a conventional power transmission device 50 shown in FIG. 10, a hub 204 is consist of an annular part 2043 and a hub seat surface 2045 in an integral construction and comes into contact with a washer 6. The washer 60 comes into contact with a shaft seat surface 403 of the compressor. As described above, the hub 2 as well as the washer 6 is sandwiched between the power transmission shut-off member 3 coupling to the rotating shaft 4 by means of a thread member and the shaft seat surface (stepped portion) 403 of the rotating shaft 4 and is compressed so that the power transmission shut-off member 3 and the hub 2 rotate together with the rotating shaft 4 in an integral state.

FIG. 11 and FIG. 12 are diagrams for explaining a configuration after the power transmission shut-off member 3 has operated and has been ruptured. In FIG. 11, if the power transmission shut-off member 3 is ruptured, a ruptured surface 306 is formed and the power transmission shut-off member is split into a flange part 303 and a limiter thread member 307. The ruptured surfaces are not necessarily flat plane-shaped. Therefore, in FIG. 12, as the flange side ruptured surface 3a rotates the thread member side ruptured surface 3b, the limiter thread member 307 of the power transmission shut-off member advances toward the side of the compressor (apparatus to be driven). Due to this phenomenon, a gap 9 formed in FIG. 11 is eliminated, the limiter thread member 307 of the power transmission shut-off member interferes with a hub seat part 2045, and further, the hub seat part 2045 is sandwiched by an shaft seat surface on the rotating shaft side, and thus power is transmitted. In other words, even if the power transmission shut-off member 3 has operated and has been ruptured, power transmission is not shut off and a problem arises that the power is transmitted to the rotating shaft and further to the apparatus to be driven such as the compressor.

[Patent document 1] Japanese Unexamined Patent Publication (Kokai) No. 2003-206950

### SUMMARY OF THE INVENTION

The above-described circumstances being taken into account, the present invention has been developed and an object thereof is to provide a power transmission device capable of avoiding troubles such as that power cannot be shut off even if a torque limiter operates in a torque limiter system utilizing threaded fastening.

To realize the above-mentioned objects, in a first aspect of the present invention, a power transmission device (10) comprises: a rotatable rotary part (1) to which a rotary driving force is transmitted from a driving source; and a power transmission shut-off member (3) for preventing an excessive torque from being transmitted between the rotatable rotary part (1) and a rotating shaft (4) of an apparatus to be driven. The power transmission shut-off member (3) is coupled to the rotating shaft (4) by a thread. A hub (2) is arranged between the rotary part (1) and the power transmission shut-off member (3) and connects them. The hub (2) is located so as to be sandwiched between the power transmission shut-off member (3) and the rotating shaft (4). The power transmission device (10) further comprises a washer (6) located so as to be sandwiched between the hub (2) and the rotating shaft (4). The washer (6) is separated from the hub (2) in construction, and the power transmission device (10) is configured so that the hub (2) is not sandwiched between the washer (6) and an end surface (308) of the power transmission shut-off member (3) near the rotating shaft.

By configuring as described above, the power transmission can be smoothly shut off by completely separating the hub from the washer in construction in the torque limiter system utilizing threaded fastening, and as a result, it is possible to avoid the trouble that power transmission cannot be shut off even if the power transmission shut-off member operates and is ruptured.

In a second aspect of the present invention according to the first aspect, a step-like shaft seat surface (403) is formed on the rotating shaft (4) so as to face the power transmission shut-off member (3).

According to the present aspect, the shaft seat surface (403) supports the washer.

In a third aspect of the present invention according to the first or second aspect, a maximum outer diameter (α) of the end surface (308) of the power transmission shut-off member (3) near the rotating shaft is smaller than an inner diameter (β) of an inner hub (204) surrounding a thread member (307) of the power transmission shut-off member (3) of the hub (2).

According to the present aspect, a part of the ruptured power transmission shut-off member does not sandwich the inner hub, and therefore, the power transmission shut-off is securely performed.

In a fourth aspect of the present invention according to any one of the first to the third aspects, the maximum outer diameter (α) of the end surface (308) of the power transmission shut-off member (3) near the rotating shaft is larger than an inner diameter (γ) of the washer (6).

According to the present aspect, as the washer is necessarily sandwiched between the power transmission shut-off member and the rotating shaft, power can be smoothly transmitted.

In a fifth aspect of the present invention according to any one of the first to fourth aspects, the rotating shaft (4) comprises a threaded part (402) for coupling to the power transmission shut-off member (3) by a thread, and a straight part (404) which is provided to continuously connect to the threaded part (402) and is not threaded. In a state in which the power transmission device (10) has been assembled, the straight part (404) is formed so that the hub (2) does not come into contact with the washer (6).

According to the present aspect, as the straight part prevents the power transmission shut-off member from advancing towards the rotating shaft, it is possible to avoid the trouble that power transmission cannot be shut off.

In a sixth aspect of the present invention according to the fifth aspect, in a state in which the power transmission device (10) has been assembled, a boundary between the thread part (402) of the rotating shaft (4) and the straight part (404) is located on a position nearer the power transmission shut-off member than a contact surface (61) of the washer (6) facing the hub (2).

According to the present aspect, an aspect is disclosed in which the configuration according to the fifth aspect is further embodied.

A seventh aspect of the present invention according to any one of the first to sixth aspects is characterized in that the power transmission device is coupled to a compressor of an air conditioner for a vehicle as an apparatus to be driven.

According to the present aspect, an aspect that further embodies the use of the present invention is disclosed.

In an eighth aspect of the present invention, a power transmission device (10) comprises: a rotatable power transmission shut-off member (3) capable of rotating together with a rotating shaft (4) of a driven apparatus by coupling to the rotating shaft (4) by a thread; and a rotary part (1, 2) to which a rotary driving force is transmitted from a driving source and which connects to the power transmission shut-off member (3). The rotating shaft (4) comprises a step-like shaft seat surface (403) with which the rotary part (1, 2) comes into contact directly or indirectly. The power transmission shut-off member (3) serves to prevent an excessive torque from being transmitted from the rotary part (1, 2) to the rotating shaft (4) by a threaded fastening part moving in a direction toward the shaft seat surface (403) when an excessive torque is transmitted from the rotary part (1, 2) to the rotating shaft (4). In addition, the rotary part (1, 2) does not go into a space between the power transmission shut-off member (3) and the shaft seat surface (403).

By configuring as described above, the power transmission can be smoothly shut off as the rotary part (1, 2) is not sandwiched between the power transmission shut-off member (3) and the shaft seat surface (403) even when the power transmission shut-off member (3) has operated and a part thereof moves, in the torque limiter system utilizing threaded fastening, and as a result, it is possible to avoid the trouble that power transmission cannot be shut off even if the power transmission shut-off member operates.

In a ninth aspect of the present invention according to the eighth aspect, the shaft seat surface (403) is provided on a position nearer the driven apparatus than the thread member to which the power transmission shut-off member (3) couples by a thread.

According to the present aspect, even if the power transmission shut-off member (3) has operated and a part thereof moves, the part cannot reach the shaft seat surface so that it is possible to securely avoid the trouble that power transmission cannot be shut off even if the power transmission shut-off member operates.

In a tenth aspect of the present invention according to the eighth or ninth aspect, the rotary part (1, 2) comes into contact with the shaft seat surface (403) via the washer (6).

According to the present aspect, the power can be smoothly transmitted via the washer.

In an eleventh aspect of the present invention according to any one of the first to the tenth aspects, the power transmission device further comprises a flange member (1000) located on a tip end part side of the rotating shaft (4) and the flange member (1000) prevents a part of the power transmission shut-off member (3) and the rotary part (1, 2) from dropping, when the power transmission shut-off member (3) has operated.

According to the present aspect, it is possible to prevents a part of the power transmission shut-off member (3) and the rotary part (1, 2) from dropping by providing a flange member on a tip end part side of the rotating shaft (4), when the power transmission shut-off member (3) has operated.

In a twelfth aspect of the present invention, a power transmission device (10) comprises: a rotary part (1, 2) which is rotatably supported on a housing of an apparatus to be driven and to which a rotary driving force is transmitted from a driving source; a contact surface (2044) provided on the rotary part (1, 2) and capable of being indirectly in contact with a shaft contact surface (403) provided on a rotating shaft of the apparatus to be driven via a power transmission member (6); and a power transmission shut-off member (3) comprising a thread member (307) coupled to the rotating shaft by a thread and a flange part (303) coupled to the thread member (307) via a rupture part (306) to press the contact surface (2044) toward the shaft contact surface (403) by an axial force produced by the thread member (307); wherein the rupture part (306) is ruptured by the axial force when an excessive torque is transmitted from the rotary part (1, 2) to the rotating shaft (4), and only the power transmission member (6) is arranged between the thread member (307) and the shaft contact surface (403).

By configuring as described above, the power transmission can be smoothly shut off by completely separating the hub from the washer in construction in the torque limiter system utilizing threaded fastening, and as a result, it is possible to avoid the trouble that power transmission cannot be shut off even if the power transmission shut-off member operates and is ruptured.

In a thirteenth aspect of the present invention according to the twelfth aspect, an outer diameter (ΦA) of the power transmission member (6) is larger than an outer diameter (ΦB) of the thread member (307), and the contact surface (2044) comes into contact with the power transmission member (6) at an outer diameter side of the thread member (307).

The figures in the brackets attached to the abovementioned means are examples showing the relationship of correspondence with the concrete means in the embodiments to be described later.

The present invention may be more fully understood from the description of the preferred embodiments of the invention set forth below, together with the accompanying drawings.

### BRIEF DESCRIPTION OF THE DRAWINGS

In the drawings:

FIG. 1 is a diagrammatic side section view of a first embodiment of a power transmission device according to the present invention.

FIG. 2 is a partially enlarged side section view of the periphery of a power transmission shut-off member in FIG. 1.

FIG. 3 is a front view of an insertion part of the power transmission shut-off member into an inner hub of a hub shown in FIG. 2.

FIG. 4 is a partially enlarged side section view showing a state just after the power transmission shut-off member has been ruptured in the first embodiment.

FIG. 5 is a partially enlarged side section view showing another state in which the power transmission shut-off device has been ruptured and the limiter thread portion advances to the washer in the first embodiment.

FIG. 6 is a drawing for explaining the conditions required for the present invention in the first embodiment.

FIG. 7 is a partially enlarged side section view of the periphery of a power transmission shut-off member of a second embodiment of the power transmission device according to the present invention.

FIG. 8 is a partially enlarged side section view of the periphery of a power transmission shut-off member of a third embodiment of the power transmission device according to the present invention.

FIG. 9 is a partially enlarged side section view of the periphery of a power transmission shut-off member of a fourth embodiment of the power transmission device according to the present invention.

FIG. 10 is a partially enlarged side section view of the periphery of a power transmission shut-off member of a power transmission device according to a prior art.

FIG. 11 is a partially enlarged side section view showing a state just after the power transmission shut-off member has been ruptured in FIG. 10 showing the prior art.

FIG. 12 is a partially enlarged side section view showing another state in which the power transmission shut-off device has been ruptured and the limiter thread portion advances to the washer in FIG. 10 showing the prior art.

FIG. 13 is a diagrammatic side section view of a fifth embodiment of the power transmission device according to the present invention.

FIG. 14 is a partially enlarged side section view of a tip part of a shaft showing a state in which the power transmission shut-off member has been ruptured in the fifth embodiment.

### DESCRIPTION OF THE PREFERRED EMBODIMENTS

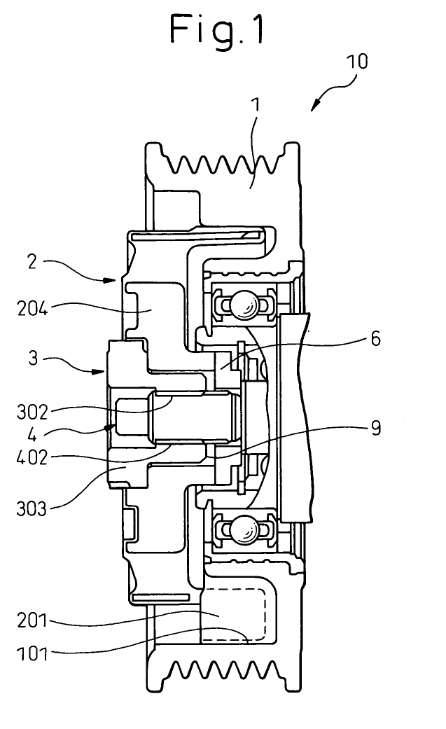

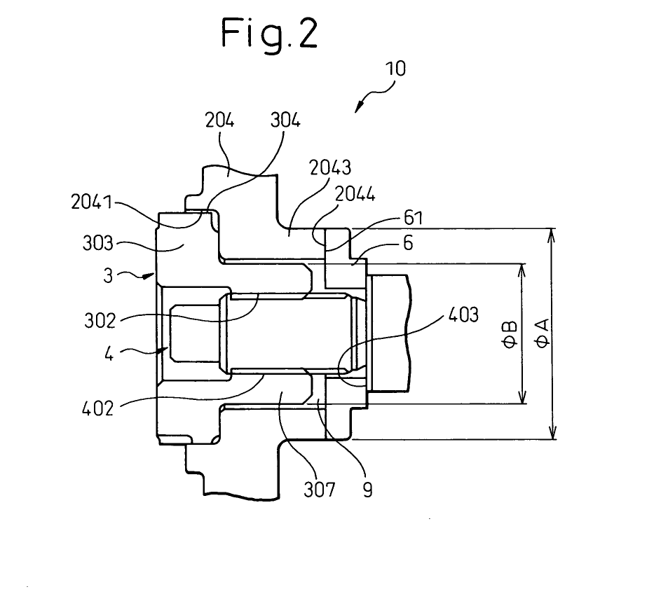

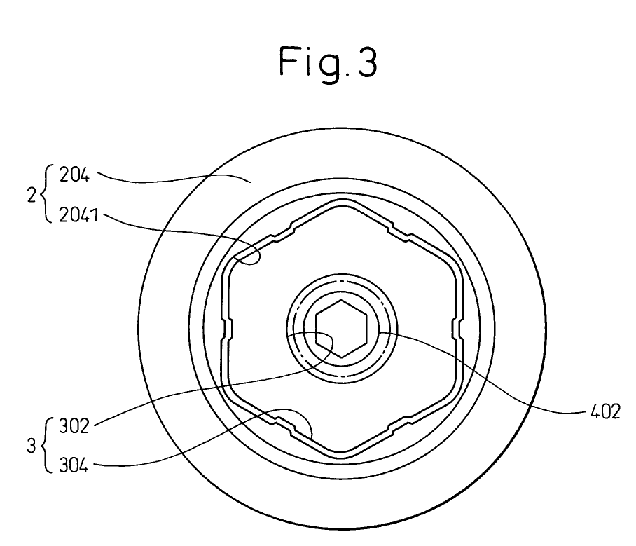

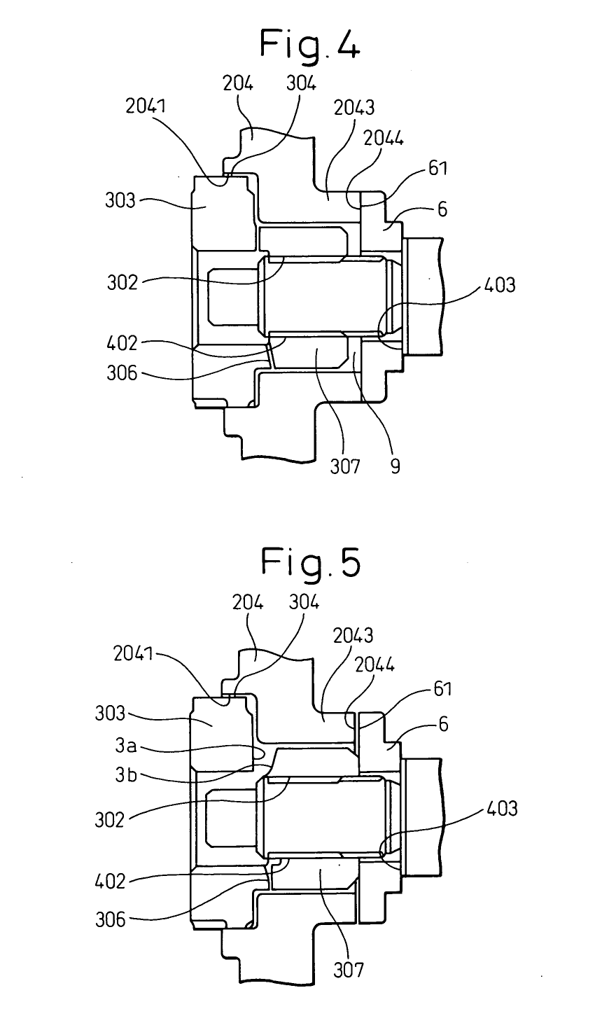

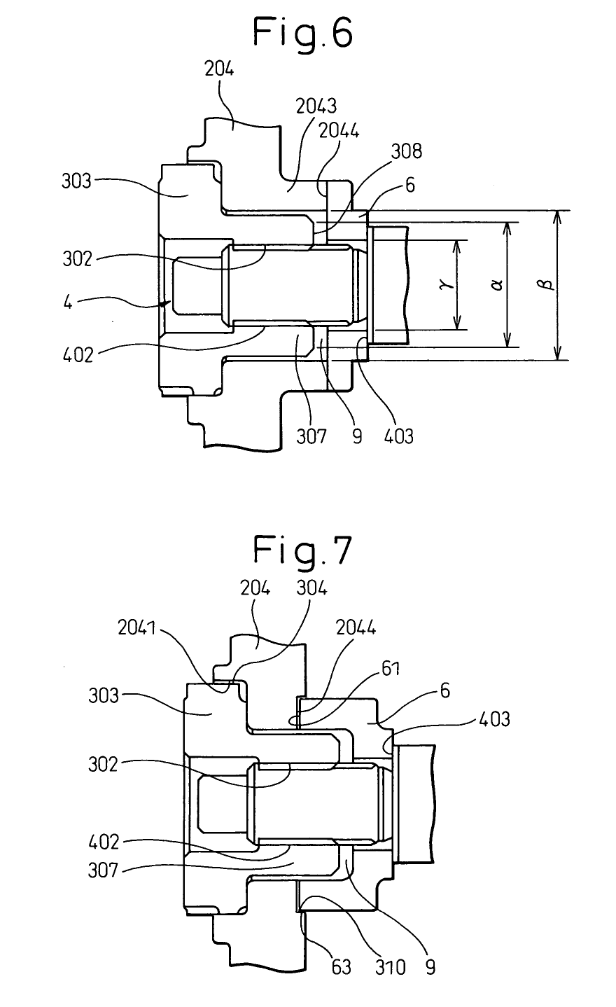

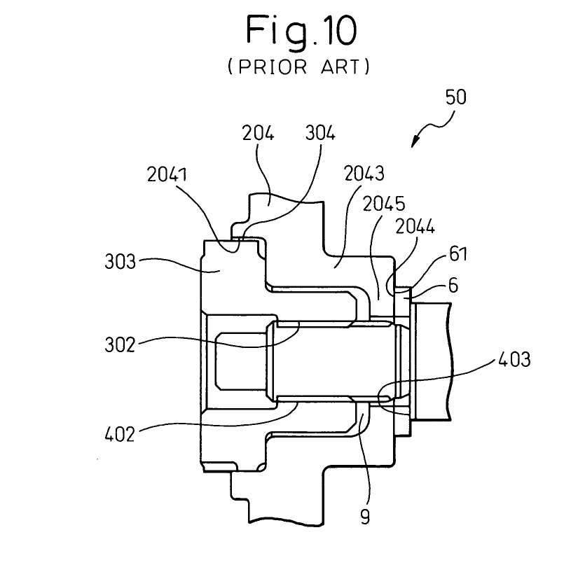

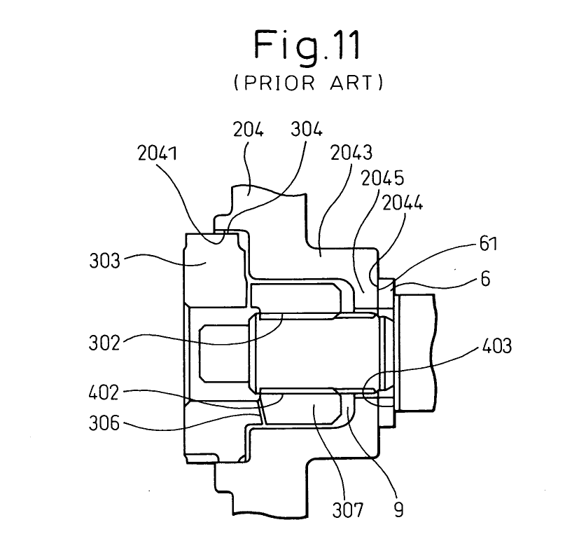

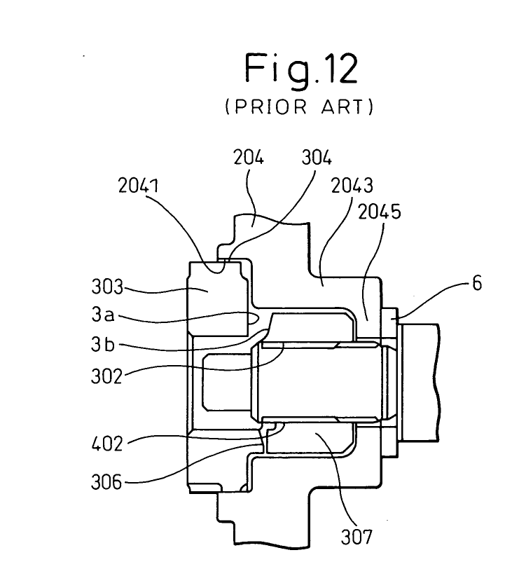

Embodiments of a power transmission device according to the present invention are described below, in detail, based on the drawings. FIG. 1 shows a diagrammatic side section view of a first embodiment of the power transmission device according to the present invention and FIG. 2 is a partially enlarged side section view of the periphery of a power transmission shut-off member in FIG. 1. FIG. 3 shows a front view of an insertion part of the power transmission shut-off member into an inner hub of a hub shown in FIG. 2. FIGS. 4 and 5 are the partially enlarged side section views showing two states in which the power transmission shut-off member has operated and is ruptured in the first embodiment. FIG. 6 is a drawing for explaining the conditions required for the present invention in the first embodiment. The symbols of the components in FIG. 1 to FIG. 6 correspond to the symbols of the similar components in the conventional example in FIG. 10 to FIG. 12.

A power transmission device 10 in the first embodiment of the present invention shown in FIG. 1 is used in an air conditioner for a vehicle, and a device for transmitting a torque (or a rotational force) of an external drive source such as an engine, or the like to a compressor of a vehicle air conditioner, comprises a power transmission shut-off member (torque limiter) 3. In the power transmission device 10, rotational power from the outside is transmitted to a pulley 1 corresponding to the rotary part as set forth in claims via a belt etc., not shown, and is transmitted to an inner hub 204 of a hub 2 by the insertion of a concave/convex part 201, constituted by an elastic member installed on the outer periphery of the hub 2, into a concave/convex part 101 of the pulley. The configuration of the pulley side concave/convex part 101 and the hub side concave/convex part 201 may be, for example, one in which a plurality of corresponding concave/convex parts are inserted into each other. Power is further transmitted from the hub 2 to the power transmission shut-off member 3 and the inner hub 204 and the power transmission shut-off member 3 are inserted into each other by spigot insertion (insertion connection such as inserting a pipe into a socket) at the insertion part 2041 of the inner hub, as shown in FIG. 3 and the insertion part 304 of the power transmission shut-off member.

Torque transmission between the inner hub 204 and the power transmission shut-off member 3 may be performed by, for example, spigot insertion between the hexagonal insertion part 304, which is the outer periphery of a flange part 302 of the power transmission shut-off member 3, and the hexagonal insertion part 204 of the hub 2 or by the caulked structure of a rotation stopper, as the present embodiment shown in FIG. 3 which is a front view of FIG. 1. Alternatively, the torque may be transmitted by the spigot insertion with a shape, other than a circle, such as a quadrangle, a width-across flat, a hexagon, an octagon, a decagon, or a dodecagon, or by the fastening by threads installed on the inner hub 204 and the power transmission shut-off member 3, although not shown schematically in the present embodiment. The power transmitted from the hub 2 to the power transmission shut-off member 3 is transmitted from the power transmission shut-off member 3 to a rotating shaft 4 of a compressor (not shown) threadedly coupled to the power transmission shut-off device 3 to rotatably drive the compressor.

In FIG. 2, the inner hub 204 and the power transmission shut-off member 3 are fastened to each other by the axial force generated by the threaded coupling of a thread part 302 of the power transmission shut-off member 3 and a thread part 402 of the rotating shaft 4 of the compressor. The load of the fastening in the axial direction is supported by a washer 6 separately formed from the inner hub 204 and a gap 9 is provided between the washer 6 and the power transmission shut-off member 3. The end surface 308 of the power transmission shut-off member 3 and a contact surface 61 of the washer 6 near the hub are facing each other via the gap 9 and the inner hub 204 of the hub 2 is not located between the end surface 308 and the contact surface 61. This means that an annular part 2043 of the inner hub 204 is arranged at an outside so as to surround a limiter thread member 307 of the power transmission shut-off member 3 and the inner hub 204 does not go into a space between the power transmission shut-off member 3 and the seat surface 403 of the rotating shaft. In the embodiment shown in FIG. 2, a relationship in which the outer diameter (ΦA) of the power transmission member (6) is larger than an outer diameter (ΦB) of the thread member (307) is established and the contact surface (2044) comes into contact with the power transmission member (6) at an outer diameter side of the thread member (307).

FIGS. 4 and 5 are drawings for explaining states in which the power transmission shut-off member (the torque limiter) 3 in FIG. 2 showing the first embodiment has operated. In FIG. 4, when the power transmission shut-off member 3 operates, as the surfaces of the rupture parts may not be flat plane-shaped as same as the case of the conventional example explained before, the ruptured surface 3a at the flange side may often come into contact with and rotate the ruptured surface 3b at the thread member side. The limiter thread member 307 advances in the axial direction (toward the compressor side) by being rotated. In FIG. 5, the limiter thread member 307 sandwiches the washer 6 when it advances. As the washer 6 is separated from the hub 2 in its construction, the limiter thread member 307 which comes into contact with the washer 6 pushes the flange part 303 toward the outside (to the left direction in FIG. 5) so that the contact surface 2044 of the hub 2 which has been in contact with the washer 6 is moved to separate from the washer 6. Therefore, the power is completely shut off.

FIG. 6 is a drawing for explaining the conditions which are required to realize the present embodiment. In a relationship among the maximum outer diameter α of the end surface 308 of the power transmission shut-off member 3 near the thread advancing side, the minimum inner diameter β of the annular part 2043 of the hub and the inner diameter γ of the washer 6, a relationship of γ<α<β is required in the present invention. The end surface 308 of the power transmission shut-off member 3 near the thread advancing side is provided on the limiter thread member 307 of the power transmission shut-off member 3. By establishing a relationship of α<β, the inner hub 204 cannot be sandwiched between the limiter thread member 307 and the washer 6 and by establishing a relationship of γ<α, the washer 6 is always sandwiched between the limiter thread member 307 and the shaft seat surface 403 of the rotating shaft 4 so that it is not possible for the limiter thread member 307 to come into direct contact with the rotating shaft 4. As described above, when the power transmission shut-off member 3 is ruptured, it is not possible for the hub 2 to be sandwiched between the power transmission shut-off member 3 and the washer 6. The annular part 2043 of the hub may comprise a contact surface (seat surface) in contact with the compressor.

FIG. 7 shows a partially enlarged side section view of the power transmission device of a second embodiment of according to the present invention and corresponds to FIG. 2. When a washer 6 is formed as an annular shape and is formed to provide a seat surface of a limiter thread member 307, the same effects as in the first embodiment is obtained. The side of the annular washer 6 near the hub is loosely inserted between the inner diameter 310 of an insertion portion (a contact surface) 2044 recessed on the hub and the outer diameter 63 of the washer 6.

The configuration of the second embodiment other than described above is basically the same as that of the first embodiment so that it is not further described.

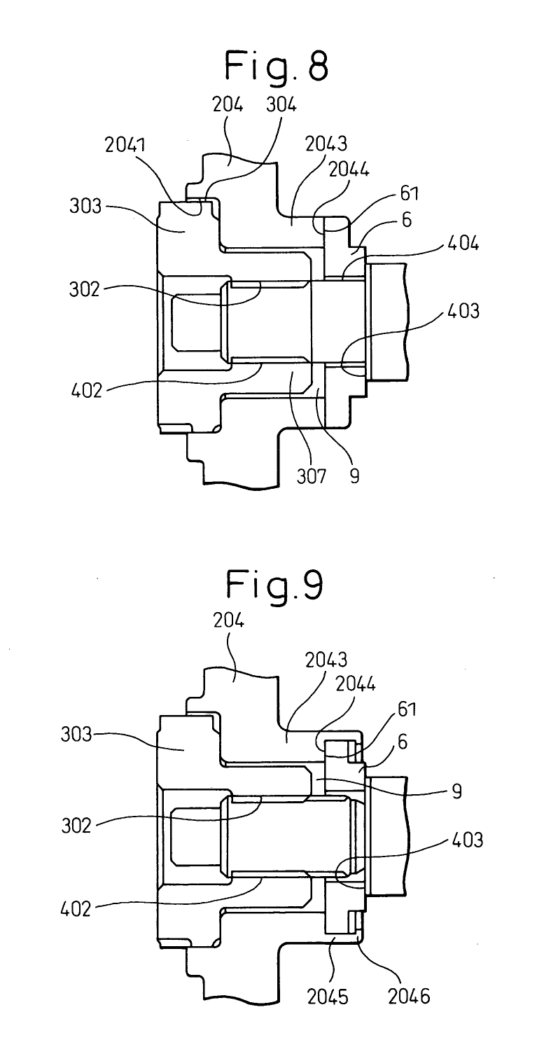

FIG. 8 shows a partially enlarged side section view of the power transmission device of a third embodiment of according to the present invention and corresponds to FIG. 2. FIG. 8 shows a configuration in which a rotating shaft 4 of the compressor comprises a straight part 404 which is not provided with threads. According to this configuration, if the limiter thread member advances in the axial direction, as the washer 6 is not sandwiched, the power transmission is shut off without fail. The straight part 404 preferably has a length equal to or larger than the thickness of the washer 6 and in this case the washer 6 may be integrally formed with the hub 2. In this case, the construction in which the washer 6 is separated from the inner hub 204 is a voluntary additional item. In addition, in case in which the straight part is short, by providing a loose insertion of the straight part in the inner diameter (γ) of the washer 6, the washer 6 can be arranged coaxially with the rotating shaft 4.

The configuration of the third embodiment other than described above is basically the same as that of the first embodiment so that it is not further described.

FIG. 9 shows a partially enlarged side section view of the power transmission device of a fourth embodiment of according to the present invention and corresponds to FIG. 2. FIG. 9 shows an embodiment in which a collar part 2045 of the hub is provided and a washer 6 separately formed from the hub is inserted and is rotatably combined into one unit by caulking or the like. In this embodiment, even if the washer 6 is sandwiched by the limiter thread member 307, as the hub 2 can rotate with respect to the washer 6, the power transmission can also be shut off.

The configuration of the fourth embodiment other than described above is basically the same as that of the first embodiment so that it is not further described.

In the figures showing the second, third and fourth embodiments, that is, FIGS. 7 to 9, the reference symbols of the components in FIGS. 7 to 9 correspond to those of the same or the like components in the first embodiment shown in FIGS. 1 to 6. In the second and fourth embodiments a relationship of γ<α<β is established as in the first embodiment and in the third embodiment at least a relationship of α<β is established.

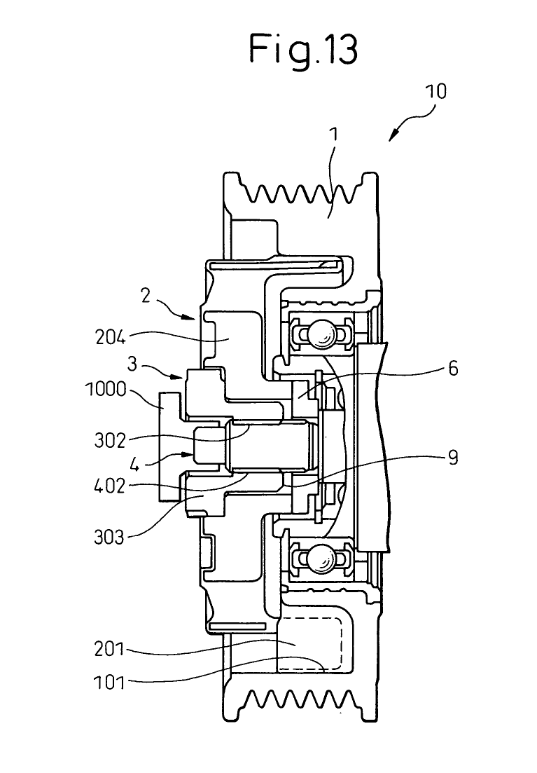

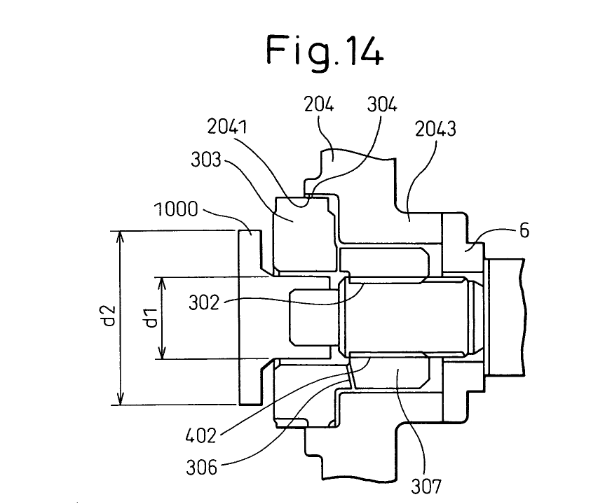

FIG. 13 shows a partially enlarged side section view of the power transmission device of a fifth embodiment according to the present invention and corresponds to FIG. 2. FIG. 14 shows a partially enlarged side section view of a tip part of a rotating shaft in the fifth embodiment and shows a state in which the power transmission shut-off member operates and is ruptured. For example, in the first embodiment shown in FIG. 1, if a seat surface (washer) 6 is configured to be separated from the inner hub 204, when the power transmission shut-off member 3 operates, the power transmission is shut off, and the thread part 302 is separated from the flange part 303 in the power transmission shut-off member 3, it is possible for the flange part 303 of the ruptured power transmission shut-off member 3 and also the hub 2 to drop out from the pulley 1. This problem is likely to occur in the second to the fourth embodiments.

In order to solve this problem, as shown in FIG. 13, it is possible to avoid the flange part 303 of the ruptured power transmission shut-off member 3 and the hub 2 from dropping by providing a flange member 1000 on the tip part of the rotating shaft 4 of the compressor when the power transmission shut-off member 3 operates. In this embodiment, as the removable flange member 1000 is inserted with, and connects to, the tip part of the rotating shaft 4, it is difficult for the removable flange member 1000 to drop. The connection of the flange member 1000 to the tip part of the rotating shaft 4 may be performed by other connecting methods known to a person with ordinary skill in the art, such as a bolt or the like. In order to prevent the flange part 303 and the hub 2 from dropping when the power transmission shut-off member 3 is ruptured, a relationship between the maximum outer diameter (maximum outer dimension) d2 of the flange member 1000 and the minimum diameter (or minimum diameter of the hub after the power transmission has been shut off) d1 of the rupture part 301 of the power transmission shut-off member 3 is d1<d2. In this configuration, the dimensional relationship between the flange member 1000 and the flange part 303 or the rupture part 301 of the power transmission shut-off member 3 may be a part that prevents the flange part 303 from dropping out by making the flange part 303 or the rupture part 301 attach to the flange member 1000. In addition, the front shape of the flange member 1000 may be formed in various shapes, such as circle, a hexagon, a triangle, a rectangle, etc. and is not specially specified.

The configuration of the fifth embodiment other than described above is basically the same as that of the first embodiment so that it is not further described.

Next, the effect and function of the above-mentioned embodiments will be explained.

The following effect can be expected from the power transmission device in the first embodiment according to the present invention.

In a torque limiter system utilizing a threaded fastening, it is possible to perform a smooth shut-off of a power transmission and to avoid a trouble that power transmission cannot be shut off even when a power transmission shut-off member is ruptured by completely separating, in construction, the inner hub to which a power is transmitted from the pulley, from a washer which is provided between the inner hub and the rotating shaft of a compressor and serves as a seat surface part for supporting the inner hub.

The same effects as those of the first embodiment can be expected from the power transmission devices of the second, third and fourth embodiments according to the present invention. In the third embodiment described above, it is not necessary for the inner hub to be separated from the washer in construction.

Following effects can be expected from the power transmission device of the fifth embodiment according to the present invention, in addition to the effects of the first embodiment.

It is possible to avoid a part of the power transmission shut-off member and the hub from dropping out by providing a flange member on a tip part of the rotating shaft of the compressor when the power transmission shut-off member operates.

In the above-mentioned embodiments, the example in which the present invention is used as a power transmission device for the compressor of an air conditioner for a vehicle is shown, however, the present invention may be applied to a use other than this and the application of the present invention is not limited to use in an air conditioner for a vehicle.

In the above description or in the embodiments shown in the accompanied drawings, the power of the drive source is explained by a configuration in which power is transmitted via a belt and pulley, however, the present invention is not limited to this and for example, power may be transmitted via another mechanism such as a gear wheel, or the like.

The above-mentioned embodiments are examples of the present invention and in no case is the present invention limited by the embodiments. It is specified only by the items described in claims and various embodiments other than those mentioned above are possible.

While the invention has been described by reference to specific embodiments chosen for the purposes of illustration, it should be apparent that numerous modifications could be made thereto, by those skilled in the art, without departing from the basic concept and scope of the invention.

1. A power transmission device comprising:
a rotatable rotary part to which a rotary driving force is transmitted from a driving source;
a rotatable power transmission shut-off member for preventing an excessive torque from being transmitted between the rotary part and a rotating shaft of an apparatus to be driven and capable of rotating together with the rotating shaft by coupling to the rotating shaft by a thread; and
a hub connecting, on one hand, to the rotary part and connecting, the other hand, to the power transmission shut-off member; wherein
the hub is located so as to be sandwiched between the power transmission shut-off member and the rotating shaft; and wherein
the power transmission device further comprises a washer located so as to be sandwiched between the hub and the rotating shaft, the washer is separated from the hub, in construction, and the power transmission device is configured so that the hub is not sandwiched between the washer and an end surface of the power transmission shut-off member near the rotating shaft.

2. The power transmission device as set forth in claim 1, wherein a step-like shaft seat surface is formed on the rotating shaft so as to face the power transmission shut-off member.

3. The power transmission device as set forth in claim 1, wherein a maximum outer diameter of the end surface of the power transmission shut-off member near the rotating shaft is smaller than an inner diameter of an inner hub surrounding a thread member of the power transmission shut-off member of the hub.

4. The power transmission device as set forth in claim 1, wherein a maximum outer diameter of the end surface of the power transmission shut-off member near the rotating shaft is larger than an inner diameter of the washer.

5. The power transmission device as set forth in claim 1, wherein the rotating shaft comprises a thread part for coupling to the power transmission shut-off member by a thread, and a straight part which is provided to continuously connect to the thread part and is not threaded, and in a state in which the power transmission device has been assembled, the straight part is formed so that the hub does not come into contact with the washer.

6. The power transmission device as set forth in claim 5, wherein in a state in which the power transmission device has been assembled, a boundary between the thread part of the rotating shaft and the straight part is located on a position nearer the power transmission shut-off member than a contact surface of the washer facing the hub.

7. The power transmission device as set forth in claim 1, wherein the power transmission device is coupled to a compressor of an air conditioner, for a vehicle, which is an apparatus to be driven.

8. A power transmission device comprising:
a rotatable power transmission shut-off member capable of rotating together with a rotating shaft of an apparatus to be driven, by coupling to the rotating shaft by a thread; and
a rotary part to which a rotary driving force is transmitted from a driving source and which connects to the power transmission shut-off member; wherein
the rotating shaft comprises a step-like shaft seat surface with which the rotary part comes into contact directly or indirectly, and wherein
the power transmission shut-off member serves to prevent an excessive torque from being transmitted from the rotary part to the rotating shaft by a threaded fastening part moving in a direction toward the shaft seat surface when an excessive torque is transmitted from the rotary part to the rotating shaft, and
the rotary part does not go into a space between the power transmission shut-off member and the shaft seat surface.

9. The power transmission device as set forth in claim 8, wherein the shaft seat surface is provided on a position nearer the apparatus to be driven than the thread member to which the power transmission shut-off member couples by a thread.

10. The power transmission device as set forth in claim 8, wherein the rotary part comes into contact with the shaft seat surface via the washer.

11. The power transmission device as set forth in claim 1, further comprising a flange member; wherein
the flange member prevents a part of the power transmission shut-off member and the rotary part from dropping by locating the flange member on a tip end part side near a side of the rotating shaft opposing to the apparatus to be driven when the power transmission shut-off member operates.

12. A power transmission device comprising:
a rotary part which is rotatably supported on a housing of an apparatus to be driven and to which a rotary driving force is transmitted from a driving source;
a contact surface provided on the rotary part and capable of being in indirect contact with a shaft contact surface provided on a rotating shaft of the apparatus to be driven, via a power transmission member; and
a power transmission shut-off member comprising a thread member coupled to the rotating shaft by a thread and a flange part coupled to the thread member via a rupture part to press the contact surface toward the shaft contact surface by an axial force produced by the thread member; wherein
the rupture part is ruptured by the axial force when an excessive torque is transmitted from the rotary part to the rotating shaft, and
only the power transmission member is arranged between the thread member and the shaft contact surface.

13. The power transmission device as set forth in claim 12, wherein
an outer diameter of the power transmission member is larger than an outer diameter of the thread member, and
the contact surface comes into contact with the power transmission member at an outer diameter side of the thread member.

14. The power transmission device as set forth in claim 8, further comprising a flange member; wherein
the flange member prevents a part of the power transmission shut-off member and the rotary part from dropping by locating the flange member on a tip end part side near a side of the rotating shaft opposing to the apparatus to be driven when the power transmission shut-off member operates.
